(19) United States
(12) Patent Application Publication
(10) Pub. No.: US 2006/0045187 A1
(43) Pub. Date: Mar. 2, 2006

(54) Method and system for processing a digital video signal

(75) Inventors: Stephane Auberger, Paris (FR); Yann Picard, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS , N.V., Eindhoven (NL)

(21) Appl. No.: 10/528,627

(22) PCT Filed: Sep. 17, 2003
(86) PCT No.: PCT/IB03/04083

§ 371 Date: Mar. 22, 2005

(30) Foreign Application Priority Data
Sep. 25, 2002 (EP) 02292353.6

(51) Int. Cl. H04N 11/02; H04N 11/04; H04N 7/12; H04B 1/66

(52) U.S. Cl. 375/240.25; 375/240.01

(57) ABSTRACT

The present invention relates to a video communication system (SYS), which is able to receive a digital video signal, said digital video signal comprising some sets of objects (OBJ) with components (COMP). The invention is characterized in that it comprises:—availability information (FLAG) for determining if a component (COMP) of said object (OBJ) is to be encoded and transmitted via the transmission channel (CM),—encoding means for encoding a component (COMP) of said object (OBJ) if the availability information (FLAG) is enabled,—decoding means for decoding said component (COMP) of said object (OBJ) if the availability information (FLAG) is enabled, and,—retrieving means for retrieving said component (COMP) of said object (OBJ) if availability information (FLAG) is disabled.

### FIELD OF THE INVENTION

The present invention relates to a video communication system, which is able to receive a digital video signal, according to the preamble of claim 1. The invention further relates to a method of processing a digital video signal according to the preamble of claim 8.

Such a system may be used, for example, for 3D video applications within MPEG standards.

### BACKGROUND OF THE INVENTION

A video communication system typically comprises a transmitter with an encoder and a receiver with a decoder. Such a system receives an input digital video signal, encodes said signal via the encoder, transmits the encoded signal to the receiver, then decodes the transmitted signal via the decoder resulting in an output digital video signal, which is the reconstructed signal of the input digital video signal. The receiver then displays said output digital video signal. A digital video signal comprises some sets of objects, which are characterized by components such as shapes, textures, motion information, disparity map (in the case of 3D video signal), etc.

When an object is encoded, the components of said object are encoded. The encoding and decoding processes of each video component can more or less depend on each other. Coding performance relies on this inter-dependence.

Let us give an example with 3D video objects encoded by using the MPEG4 standard. In this document referred to under the MPEG-4 document number w3056 at ISO and entitled “Information Technology—Coding of audio-visual objects—Part 2: Visual, ISO/IEC JTC 1/SC 29/WG 11, Maui, December 1999”, when one encodes a stereo video sequence comprising two views, one view—say the left one—and the corresponding disparity maps (or depth maps) are encoded. The right view is reconstructed by projecting the left view using the disparity map. Parts of the right view that were not in the left one (occlusion parts) cannot be reconstructed and holes remain. In order to reconstruct the right view properly, one encodes the occlusion parts retrieved from the original right view as an MPEG-4 video object, whose shape corresponds to the holes. If the left view is encoded at a bit rate of 3.5 Mbit/s, the enhancement layer defined to handle occlusion parts should not be larger than 10% of this bit rate. Here it takes 340 kbit/s. Occlusion objects are defined by shape and texture. Using the standard way of coding objects, their bit rate costs are:
Shape: 93 kbit/s i.e. 27% of the bit rate allocated to occlusion
Texture: 128 kbit/s i.e. 37% of the bit rate.
   The occlusion shapes can be determined from the disparity map. Still, component encoding being interdependent, it is not possible to efficiently encode the texture of the occlusion parts, without encoding the shapes. Therefore, the bit rate cost of the video sequence is not optimal.

### OBJECT AND SUMMARY OF THE INVENTION

Accordingly, it is an object of the invention to provide a video communication system as defined in the preamble of claim 1 and a method as defined in the preamble of claim 8, which lower the bit rate needed to encode objects.

To this end, according to a first object of the invention, there is provided a video communication system as claimed in claim 1.

In addition, according to a second object of the invention, there is provided a method as claimed in claim 8.

As we will see in detail below, by providing the possibility of not encoding a first component and therefore not transmitting it while encoding the other components as if it was the case, the encoding efficiency will be improved, because fewer bits will be necessary to encode the whole object.

### BRIEF DESCRIPTION OF THE DRAWINGS

Additional objects, features and advantages of the invention will become apparent upon reading the following detailed description and upon reference to the accompanying drawings in which:

FIG. 1 illustrates a video communication system comprising an encoder and a decoder according to the invention,

FIG. 2 is schematic diagram of the encoding method used by the encoder of the video communication according to the invention, and

FIG. 3 is schematic diagram of the decoding method used by the decoder of the video communication according to the invention.

### DETAILED DESCRIPTION OF THE INVENTION

In the following description, functions or constructions well known to the person skilled in the art are not described in detail because they would obscure the invention in unnecessary detail.

The present invention relates to a video communication system for processing a digital video signal.

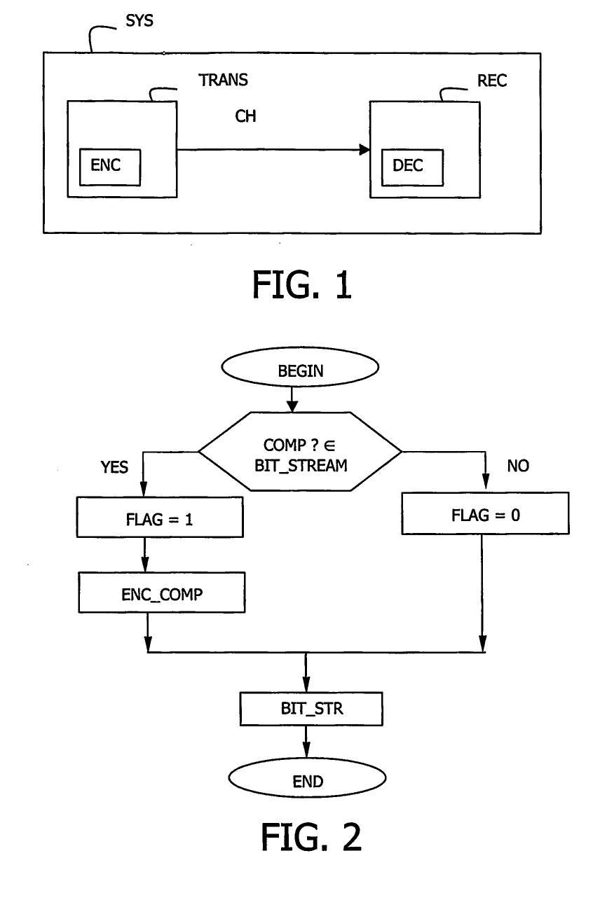

Such a system, depicted in FIG. 1, may be used for video applications in MPEG2 or MPEG4, wherein said video communication system comprises a transmitter TRANS, a transmission medium CH and a receiver RECEIV. Said transmitter TRANS and said receiver RECEIV comprise an encoder ENC and a decoder DEC, respectively.

In order to transmit efficiently some video signals through the transmission medium CH, in which the transmitted bits of the video signals are known as bit stream BIT_STR, said encoder ENC applies an encoding on a video signal, then the encoded video signal is sent to a decoder DEC, which decodes said signal. Finally, the receiver RECEIV displays said video signal.

A video signal comprises some sets of objects OBJ with different components COMP such as shape, texture, motion vectors, disparity map, colors, etc.

When the encoder ENC encodes an object OBJ, it encodes effectively all the components COMP of said object OBJ. Much encoding of components is dependent from other components. For example, in the INTER mode scheme, well known to the person skilled in the art, texture information can be used only if we have motion information. When it comes to video object coding, in MPEG-4 using the block-based principle, texture block positions are determined by shape, and knowing this shape allows improvement of coding efficiency by using spatial redundancy between co-located texture blocks.

The encoder ENC comprises availability information FLAG for determining if a component COMP of an object is to be encoded, or not, encoding means for encoding said component COMP if said availability information FLAG is enabled, and transmission means for transmitting said component COMP of said object OBJ if the availability information FLAG is enabled.

The decoder DEC comprises decoding means for decoding a component COMP if the availability information FLAG is enabled and retrieving means for retrieving said component COMP if the availability information FLAG is disabled.

The encoding of an object OBJ is done by the encoder ENC as follows, illustrated in FIG. 2.

For each component COMP of the object OBJ, the encoder ENC decides if said component COMP will be included in the bit stream BIT_SIR or not. Decision depends on the type of video application: for example, in a stereo system where one encodes the occlusion part, one knows that there is no need to encode and transmit the shape of these occlusions.

Availability information FLAG is assigned to each component COMP of the object OBJ. If a component COMP is to be included in the bit stream, i.e. encoded and transmitted, the availability information FLAG is enabled. Preferably, this availability information FLAG is placed at video object level (VO in MPEG-4).

In a first non-limitative embodiment, this availability information FLAG has two values: 1, when enabled, and 0 when disabled.

In a second non-limitative embodiment, this availability information FLAG has an extended syntax: 1, when enabled, and 0 plus a description codeword when disabled. The description codeword tells how to retrieve the missing component COMP (wait for extra input, like a pre-computed shape, wait for extra input and n^{th} component information, etc. . . . ). Afterwards, the decoder DEC will use this description codeword to retrieve a component COMP. It is supposed that at the decoder side, the way to retrieve a missing component COMP is well known and retrieval algorithms are available.

Subsequently, the encoder ENC encodes all the components COMP (step ENC_COMP in FIG. 2) that will be included in the bit-stream BIT_STR and for the components COMP_D, which need the missing components COMP_M, it encodes them as if all the components COMP of the object OBJ and especially the missing components COMP_M have been used, encoded and transmitted as well. Indeed, some of the coding components may require the use of other components as described before.

Note that the availability information FLAG and potentially description codeword (depending on the kind of availability information used in the application) are defined for each object components COMP. The encoded video object OBJ then corresponds to all these availability information FLAG, along with the included encoded components COMP. Hence, the bit stream BIT_STR that is transmitted to the decoder comprises the availability information FLAG of the missing components, and for every other component, their corresponding availability information FLAG and the encoded component COMP itself.

Note that the following hypothesis has been made. We suppose that we have an encoding algorithm where video objects OBJ fall into several components and that they correspond to different, separable parts of the bit stream BIT_STR It means that it is possible to replace one component without preventing the decoding process of another component. For example, in MPEG4, if we encode a video sequence with texture and depth information, if we replace or modify the encoded texture information, it is still possible to decode depth. Furthermore, if we change the motion vector components, it is possible to decode the texture—even though we have a sequence that is visually different from the original, but the encoded texture information is still correct.

Said encoded bit stream BIT_STR is then sent to the decoder DEC of the receiver RECEIV, via the transmission medium CH.

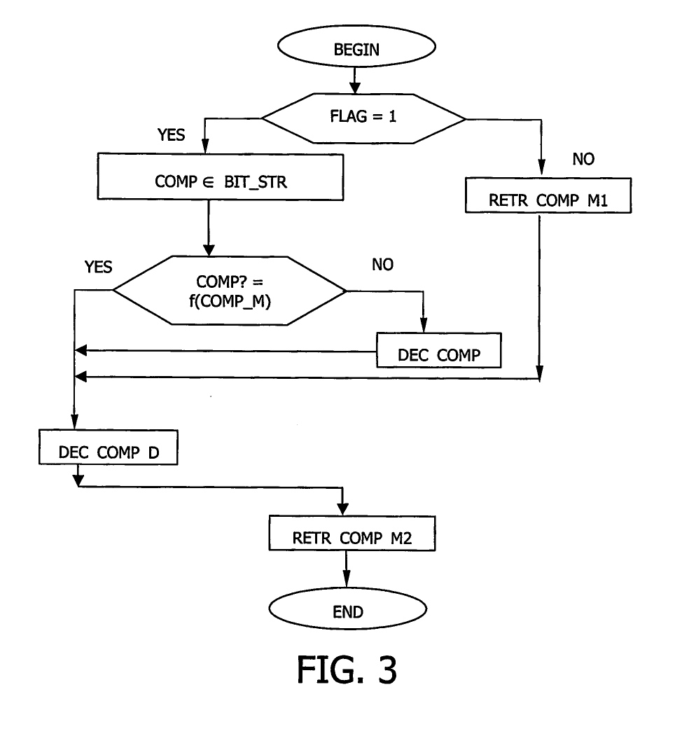

The decoding of the encoded bit-stream BIT_STR is performed by the decoder DEC as follows and as illustrated in FIG. 3.

When receiving the encoded bit-stream BIT_STR, the decoder DEC first checks the availability information FLAG in said bit-stream BIT_STR. If availability information FLAG is set to 1, it waits for the corresponding components COMP in the bit-stream BIT_STR, which follow their assigned availability information FLAG. Then, it decodes them. It first decodes the components COMP that do not need any other encoded components or missing components COMP_M (step DEC_COMP in FIG. 3), and then the components COMP_D that are dependent on the other encoded components and on the missing components COMP_M. For these later dependent components COMP_D, the decoder DEC retrieves the missing components COMP_M (step RETR_COMP_M1 in FIG. 3) and then decodes these dependent components COMP_D (step DEC_COMP_D in FIG. 3). The dependence relation between components is application dependent: in a stereo video decoder, we could say that when decoding the occlusion shape, one uses the decoded disparity map—this could be done by introducing a description codeword meaning “Retrieved from Disparity”. To take a more general case, in the MPEG coding scheme, texture information is retrieved from motion vector and a previous frame.

Once all of the encoded components COMP are decoded, the decoder DEC retrieves the last missing components COMP_M (step RETR_COMP_M2 on the FIG. 3). Note that this last step can also be performed at any other time, for example, at the beginning.

The bit stream BIT_STR is as if none of the components has been removed. The decoding process, well known to the person skilled in the art, is possible, as if every component has been regularly encoded and transmitted.

Thus, one advantage of the present invention is to simply decrease the bit rate used to encode an object by only using availability information FLAG, and to simply informing the decoder that it needs to retrieve some components itself.

It is to be understood that the present invention is not limited to the aforementioned embodiments and variations and modifications may be made without departing from the spirit and scope of the invention as defined in the appended claims. In this respect, the following closing remarks are made.

It is to be understood that the present invention is not limited to the aforementioned video application. It can be used within any application using a system for processing a signal that is decomposed into several components, the encoding of which results in separated bit-stream parts. In particular, the invention applies to video compression algorithms of the other MPEG standards family (MPEG-1, MPEG-2) and to the ITU H26X family (H261, H263 and extensions, H261 being the latest today, reference number Q15-K-59).

It is to be understood that the method according to the present invention is not limited to the aforementioned implementation.

There are numerous ways of implementing functions of the method according to the invention by means of items of hardware or software, or both, provided that a single item of hardware or software can carry out several functions. It does not exclude that an assembly of items of hardware or software or both carries out a function, thus forming a single function without modifying the method of processing the video signal in accordance with the invention.

Said hardware or software items can be implemented in several manners, such as by means of wired electronic circuits or by means of an integrated circuit that is suitably programmed. The integrated circuit can be accommodated in a computer or in a video system communication. In the second case, the video system communication comprises encoding means for encoding a component of an object if the availability information is enabled, decoding means for decoding said component of said object if the availability information is enabled, and retrieving means for retrieving said component of said object if the availability information is disabled, as described previously, said means being hardware or software items as stated above.

The integrated circuit comprises a set of instructions. Thus, said set of instructions comprised, for example, in a computer programming memory or in a video communication system may cause the computer or the video communication system to carry out the different steps of the encoding method.

The set of instructions may be loaded into the programming memory by reading a data carrier such as, for example, a disc. A service provider can also make the set of instructions available via a communication network such as, for example, the Internet.

Any reference sign in the following claims should not be construed as limiting the claim. It will be obvious that the use of the verb “to comprise” and its conjugations does not exclude the presence of any other steps or elements besides those defined in any claim. The article “a” or “an” preceding an element or step does not exclude the presence of a plurality of such elements or steps.

1. A video communication system (SYS), which is able to receive a digital video signal, said digital video signal comprising some sets of objects (OBJ) with components (COMP), comprising an encoder (ENC) for encoding said video signal, a transmission channel (CH) for transmitting the encoded video signal and a decoder (DEC) for decoding said encoded video signal, characterized in that it comprises:
availability information (FLAG) for determining if a component (COMP) of said object (OBJ) is to be encoded at the encoder (ENC) side and transmitted via the transmission channel (CH),
encoding means at the encoder side (ENC) for encoding a component (COMP) of said object (OBJ) if the availability information (FLAG) is enabled,
decoding means at the decoder (DEC) side for decoding said component (COMP) of said object (OBJ) if the availability information (FLAG) is enabled, and,
retrieving means at the decoder (DEC) side for retrieving said component (COMP) of said object (OBJ) if the availability information (FLAG) is disabled.

2. A video communication system (SYS) as claimed in claim 1, characterized in that the encoding means are adapted to encode a component (COMP) as if all the components (COMP) of said object (OBJ) have been encoded and transmitted as well.

3. A video communication system (SYS) as claimed in claim 1, characterized in that an encoded component is dependent (COMP_D) on another component (COMP), said other component being an encoded component or a missing component (COMP_D).

4. An encoder (ENC) for encoding a digital video signal, said digital video signal comprising some sets of objects (OBJ) with components (COMP), characterized in that it comprises:
availability information (FLAG) for determining if a component of said object (OBJ) is to be encoded and transmitted via a transmission channel (CH), and
encoding means for encoding a component (COMP) of said object (OBJ) if the availability information (FLAG) is enabled.

5. An encoder (ENC) as claimed in claim 4, characterized in that the encoding means are adapted to encode a component (COMP) as if all the components (COMP) of said object (OBJ) have been encoded and transmitted as well.

6. A decoder (DEC) for decoding a digital video signal, said digital video signal comprising some sets of objects (OBJ) with components (COMP), characterized in that it comprises:
decoding means for decoding a component (COMP) of said object (OBJ) if an availability information (FLAG) is enabled, and
retrieving means for retrieving a component (COMP_M) of said object (OBJ) if an availability information (FLAG) is disabled.

7. A decoder (DEC) as claimed in claim 6, characterized in that the decoding means are adapted to first decode a component (COMP) that is not dependent on another component (COMP), then to decode a component (COMP_D) that is dependent on another component, and if dependent on a missing component (COMP_M), to decode said dependent component (COMP_D) after retrieval of said missing component (COMP_M).

8. A method of processing a digital video signal, said digital video signal comprising some sets of objects (OBJ) with components (COMP), characterized in that it comprises the steps of:
by virtue of availability information (FLAG), determining if a component (COMP) of said object (OBJ) is to be encoded and transmitted via a transmission channel (CH),
encoding said component (COMP) of said object (OBJ) if the availability information (FLAG) is enabled and transmitting it,
decoding said component (COMP) of said object (OBJ) if the availability information (FLAG) is enabled, and
retrieving said component (COMP_M) of said object (OBJ) if the availability information (FLAG) is disabled.

9. A method of processing a digital video signal as claimed in claim 8, characterized in that the encoding of a component (COMP) is performed as if all the components (COMP) of said object (OBJ) have been encoded and transmitted as well.

10. A computer program product for a computer, comprising a set of instructions, which, when loaded into said computer, causes the computer to carry out the method as claimed in claims 8 and 9.
